(19) United States
(12) Patent Application Publication
(10) Pub. No.: US 2005/0231988 A1
(43) Pub. Date: Oct. 20, 2005

(54) Digital power control system

(76) Inventors: Yu-Lin Chi, Guansi Township (TW); Yong Li, Xian (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 11/103,568

(22) Filed: Apr. 12, 2005

(30) Foreign Application Priority Data
Apr. 16, 2004 (TW) 093110727

(51) Int. Cl. H02M 3/24

(52) U.S. Cl. 363/98

(57) ABSTRACT

A digital power control system provides an optimal solution to power supply. The digital power control systems comprises a direct current (DC) power supply; a state configuring device generating a plurality of state signals; a pulse generator connected to the state configuring device, converting the state signals to a plurality of waveform signals; a driving device connected to the DC power supply and the state configuring device respectively, and outputting a driving voltage according to the waveform signal; a transformer connected to the driving device, transforming the driving voltage to an AC operating voltage; and an alternating current (AC) load connected to the transformer; a feedback circuit connected to the AC load; a power detector connected to the feedback circuit for detecting the output power of the AC load, and optimizing the output power by adjusting the waveform signal outputted by the pulse generator.

### FIELD OF THE INVENTION

The present invention relates to a power control system, especially to a digital power control system that provides optimal output power by adjusting waveform signals.

### BACKGROUND OF THE INVENTION

As the technology advances to sophistication, it is feasible for the manufacturers to meet various requirements. In the consumer electronics, it has been a noticeable trend to make products that are portable with high mobility. However mobility of the products also raises concerns for the management of power consumption in order to elongate the operating duration.

For most of the mobile electronics, backlight of the display dominates the overall power consumption. Therefore, solutions to a lower power consumption of the backlight are often researched among numerous manufacturers in the industry.

FIG. 1A shows a conventional backlight power control which is widely adopted in the industry. A driving module is constructed using a DC power supply 14, a first P-channel MOS FET 161 (P-channel metal oxide semiconductor), a second PMOS FET 163, a first NMOS FET 165, and a second NMOS FET 167. Both sources of the first and second PMOS FET 161, 163 are connected to the DC power supply 14 while the drains of PMOS FET 161, 163 are connected respectively to a first NMOS 165 and a second NMOS 167. Also the drains of PMOS FET 161,163 are both connected a piezoelectric ceramic transformer 18 respectively at node A through a first inductor 181 and at node B through a second inductor 183. Furthermore, the sources of the first NMOS 165 and the second NMOS 167 remains grounded.

The control signal is generated using a pulse generator 12, which produces a periodic signal. As is shown in the waveform diagram of the periodic signal denoted as WP1 in FIG. 1B, the high voltage duration 151 should be smaller than the low voltage duration 159. The periodic signal WP1 is fed into a phase adapter 121, which then outputs three periodic signals, WP2, WN1, and WN2, each with a different phase. Furthermore, the phase difference between WN1 and WP1 remains 180 degree, same as the phase difference maintained between WN2 and WP2.

To set the high voltage duration of WP1 as the turn-on duration 151 of the first PMOS 161 and the high voltage duration of WP2 as the turn-on duration 153 of the second PMOS 163, the periodic signals WP1 and WP2 are connected, respectively, to the gate of the first PMOS 161 through a first inverter 162, and to the gate of the second PMOS 163 through a second inverter 164. Similarly WN1 and WN2 are connected to the gate of the first NMOS 165 and the gate of the second NMOS 167, respectively. This allows the high voltage duration of each periodic signal turn on its corresponding MOS FETs. For the operation of the cold cathode fluorescent lamp 19 (CCFL), an operating voltage is provided by the piezoelectric ceramic transformer 18, which is driven by the constant change of the voltage between node A and node B. In addition, a feedback circuit 191 is further connected to the cold cathode fluorescent lamp 19 in order to stabilize the power output.

To perform the function of the dimmer, the phase difference 175 between WP1 and WP2 is manipulated. The manipulation of the phase difference 175 creates an overlap time 157 between the turn-on duration 151 of the first PMOS 161 and turn-on duration 153 of the second PMOS 163. During the overlap time 157, an cancellation between the positive voltage and negative voltage changes the positive voltage duration 171 and the negative voltage duration 173, which changes the driving time and achieves the adjustment of power output.

By means of the above embodiment, power of the cold cathode fluorescent lamp 19 is manageable; therefore, the brightness of the backlight can be manipulated. However, the conventional invention is inefficient because manipulation of the power output requires that the second PMOS FET 163 producing an extra negative voltage which serves to cancel the positive voltage created by the first PMOS FET 161. In addition, inability to ensure zero voltage switching (ZVS) and failures to utilize the remaining energy in the components, such as capacitors and inductors, also raises great concern on efficient power consumption.

In addition to zero voltage switching, it is also known that the slow sampling of the current at the cold cathode fluorescent lamp 19 performed at the feedback circuit impedes efficient power consumption. The current detected at the cold cathode fluorescent lamp 19 is compared by an analog comparator to decide the power output. The method above often takes more time to compute the average power needed, which may provide an inaccurate estimation of the actual power needed during the dimming process. At last, the piezoelectric ceramic transformer 18 creates echo energy during the alternation of the driving voltages between node A and node B. The echo energy, in this conventional embodiment, will be lost while the first NMOS FET 165 and the second NMOS FET 167 are grounded.

### SUMMARY OF THE INVENTION

It is the primary object of the present invention to provide a digital power control with a state-configuring device. The state-configuring device produces digital state parameters for the system to optimize the waveform signal which drives the power system.

It is another object of the present invention to provide a digital power control that contains a status signal on which the state signal is based. A status signal is produced according to the counts of state clock signals which is generated by the charging/discharging circuit resulting from a state capacitor and the state resistors.

It is still another object of the present invention to provide a digital power control that ensures the zero voltage switching and efficient use of energy. The status signals include overlap signal, delay signal, base light signal, dim frequency signal, and echo signal.

It is still another object of the present invention to provide a digital power control with a voltage controlled oscillator at the power detector where the power clock signal can be produced through the voltage control at the output of the feedback resistor.

It is still another object of the present invention to provide a digital power control that includes a feedback capacitor in the feedback circuit. The feedback capacitor, along with a resistor, creates a charging/discharging circuit which allows the voltage controlled oscillator in the power detector to perform coupling oscillation and thereby produces the power clock signals.

It is still another object of the present invention to provide a digital power control that can significantly reduce the cost for the circuit components needed in the system. The cost reduction is achieved because the production of each state and detection of the power depend on the count of its corresponding clock signal.

It is still another object of the present invention to provide a digital power control with a set of base values for each count, which reduces the noise interference and achieve required efficiency and accuracy.

### BRIEF DESCRIPTION OF DRAWING

FIG. 1A shows a block diagram of the circuit in the conventional backlight control device;

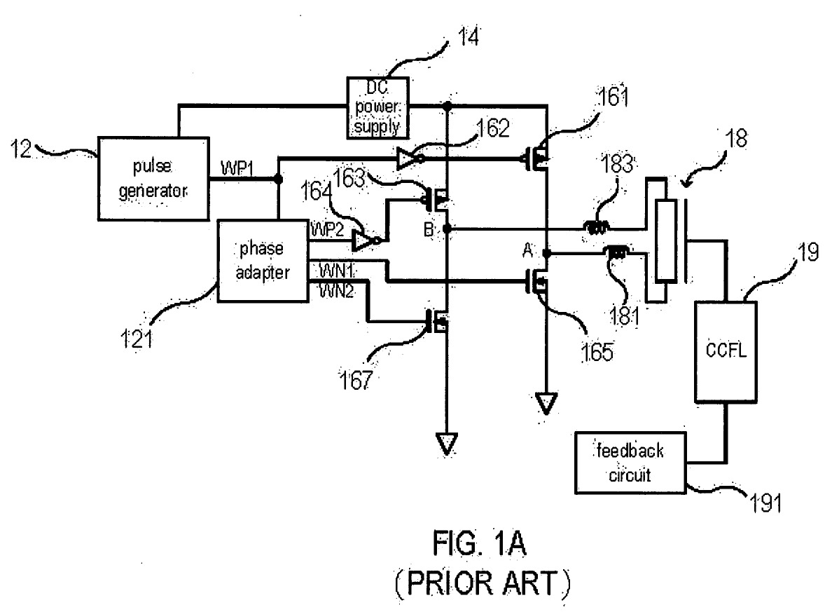

FIG. 1B shows a waveform diagram of the conventional backlight control device;

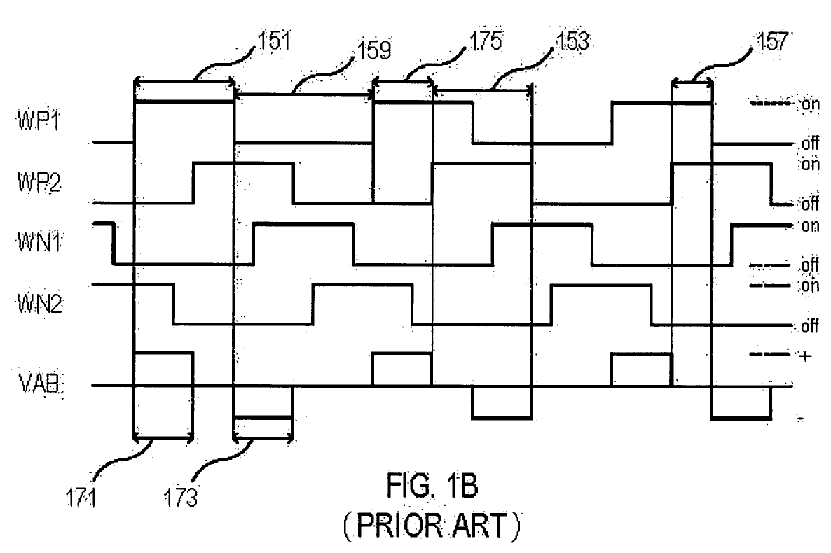

FIG. 2 shows a block diagram of the preferred embodiment of the present invention;

FIG. 3 shows a schematic diagram of the state-configuring device of the present invention;

FIG. 4 shows a partial detailed schematic diagram of the state-configuring device of the present invention;

FIG. 5 shows a waveform diagram of the state-configuring device;

FIG. 6 shows a schematic diagram of the power detector and a partial diagram of the feedback circuit in the present invention;

FIG. 7 shows a waveform diagram of the power detector;

FIG. 8 shows the block diagrams of the driving device and transformer of the present invention; and

FIG. 9 shows the timing diagram of the driving device of the present invention

### DETAILED DESCRIPTION

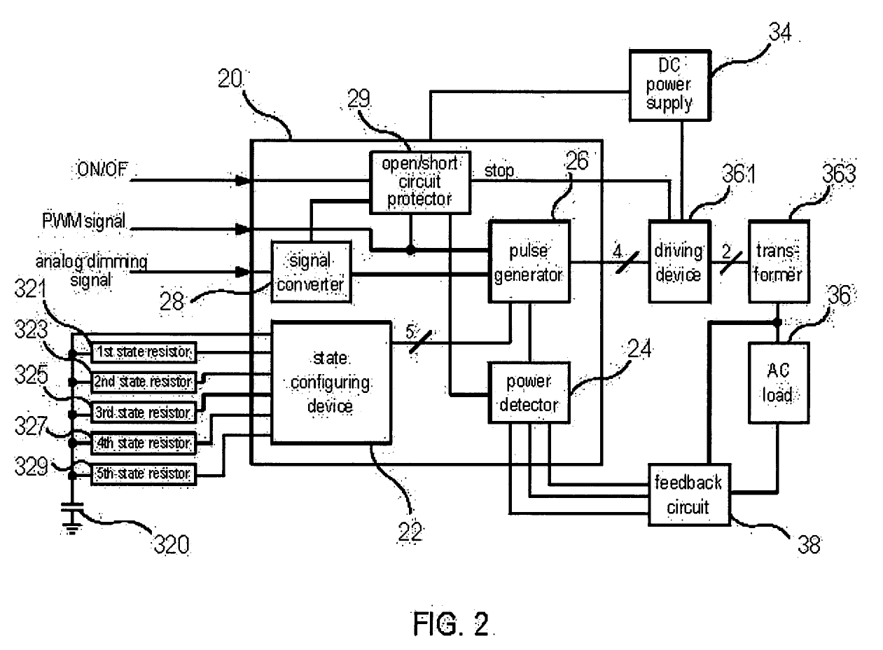

FIG. 2 shows the block diagram of the circuit in the preferred embodiment according to the present invention. The circuit includes the following components: a direct current 34, a state configuring device 22, a pulse generator 26, a driving device 361, a transformer 363, and an alternating current load 36 (AC load). The direct current 34 functions as the power supply for the whole system. The state configuring device 22 generates a plurality of digital state signals which are then sent to the pulse generator 26. The pulse generator 26 produces a waveform signal corresponding to the received state signal. The driving device 361 connects to the direct current 34 where the direct current functions as the driving voltage for the driving device 361 to output the waveform signal from the pulse generator 26 to the transformer 363. The transformer 363 transforms the output of the driving device 361 to an alternating voltage for the operation of the AC load 36.

The power control system as shown in FIG. 2 further includes a feedback circuit 38, a power detector 24, an open/short circuit protector 29 and a signal converter 28. The feedback circuit 38 connects to the AC load 36 while the power detector 24 connects to the feedback circuit 38 in order to measure the output power of the AC load 36. Sent to the pulse generator 26, the measured value of the output power serves as a power-adapting signal. Signal converter 28 receives an analog dimming signal and converts the analog dimming signal to a digital dimming signal, which is then outputted to the pulse generator 26. Open/short circuit protector 29 contains a plurality of inputs. One of the inputs of Open/short circuit protector 29 receives the turn-on/turn-off signal while another serves for the reception of pulse-width modulation signal (PWM). Another two inputs of open/short circuit protector 29 connect, respectively, to the signal converter 28 and to the feedback circuit 38 for the detection of the open/short-circuited condition at AC load 36. Under the conditions when the turn-off signal presents, or when analog dimming signal or pulse-width modulation signal is set to fully dim, or when the power detector 24 detects a short or open circuit at the transformer 363 and AC load 36, the open/short circuit protector 29 can output a protecting signal “stop” to the driving device 361 and power detector 24 to turn off the driving device 361, terminate the power supply, and disable the output of power-adapting signals from power detector 24. Based on the state signal from state configuring device 22 along with the power-adapting signal, protecting signal “stop” and the digital dimming signal, the pulse generator 26 produces the waveform signal to the driving device 361. The waveform signal, through driving device 361 and then transformer 363, is converted to AC operating voltage in order to configure AC load 36 to its targeted status.

Furthermore, the state configuring device 22 can be further connected to a grounded capacitor 320 and a plurality of state resistors, such as a first state resistor 321, a second state resistor 323, a third state resistor 325, a fourth state resistor 327, and a fifth state resistor 329. The parameters for each state can be generated by means of the charging/discharging circuits constituted between the capacitor 320 and each state resistor. The state configuring device 22, pulse generator 26, power detector 24, open/short circuit protector 29, and signal converter 28 can be further integrated into a driving microcontroller chip 20 to reduce the space needed for the system and therefore reduce the production cost.

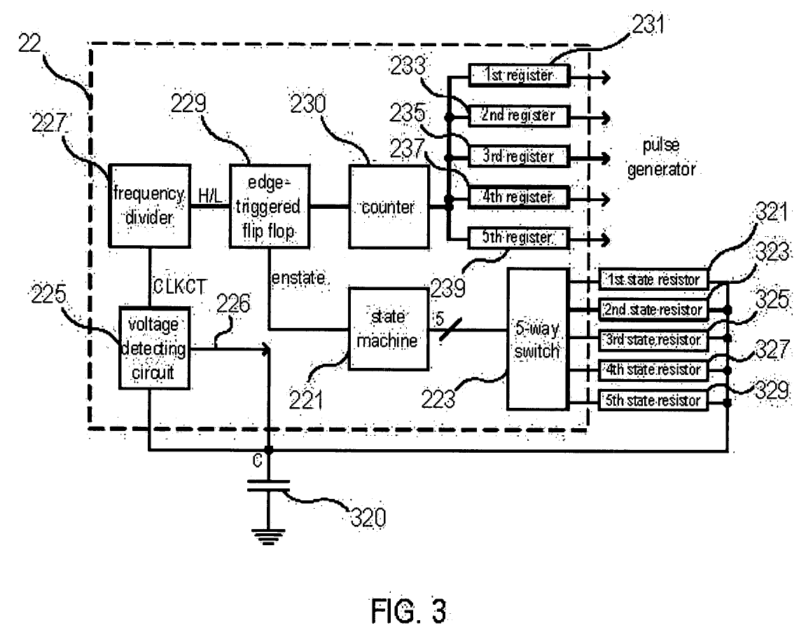

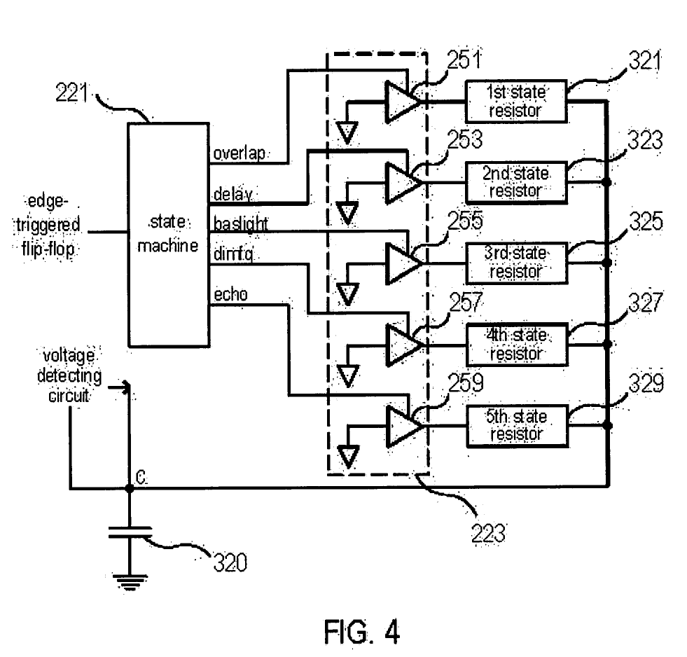

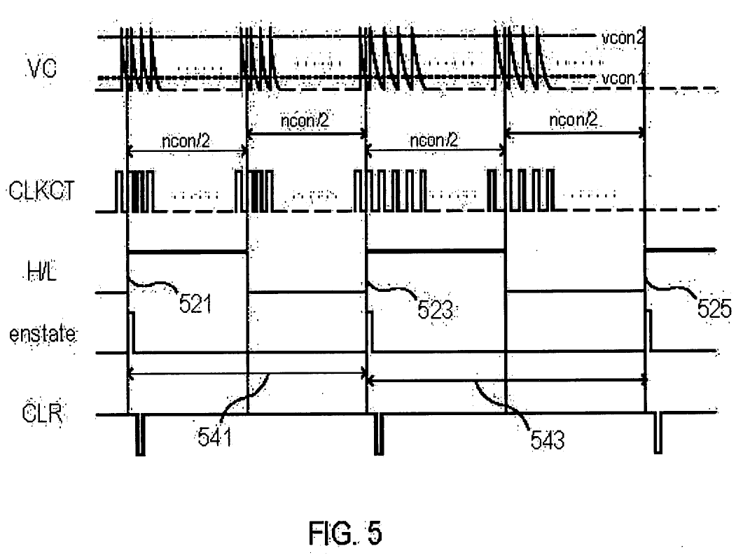

Please refer to FIG. 3, FIG. 4, and FIG. 5, which show the schematic diagram of the state configuring device 22, local detail block diagram and the waveform diagram. The main components are a state machine 221, a 5-way switch 223, a voltage detecting circuit 225, a counter 230, and a plurality of registers, such as a first register 231, a second register 233, a third register 235, a fourth register 237, and a fifth register 239.

The 5-way switch 223 is composed of five 3-state switches 251, 253, 255, 257, and 259. Each of the 3-state switches connects to an output of the state machine through, respectively, the output of status signal overlap, the output of status signal delay, the output of status signal base light, the output of status signal dim frequency, and the output of status signal echo. Each of the 3-state switches can be enabled by the presence of the status signal. The high voltage difference turns on a 3-way switch while the low voltage difference turns it off. A 3-way switch that doesn't receive its status signal remains disabled.

Each of the 3-way switches, 251, 253, 255, 257, and 259 is connected, respectively, to its corresponding state resistor 321, 323, 325, 327, 329 at one node and grounded at another node. As a result, charging/discharging circuits are constituted between the state capacitor 320 and each grounded 3-way switch. Input of the voltage detecting circuit 225 detects the voltage of the state capacitor 320 at node C to which its charging output 226 is also connected. When the voltage detected at node C is below a first threshold “vcon1”, the voltage detecting circuit 225 outputs a high voltage signal and starts charging the state capacitor 320 through its charging output 226. While the voltage detected rises above a second threshold “vcon2”, the voltage detecting circuits 225 outputs a “low voltage” signal and stops charging through its charging output 226. During the process of charging, voltage difference at the 3-state switches, if enabled by the status signal, will rise and cause a 3-state switch to be conducting, which therefore initiates discharging of the capacitor 320 through the corresponding state resistor. When the voltage difference drops below a certain value because of discharging, the 3-state switch is turned off, which leads back to the charging of the capacitor 320.

Voltage variation of node C is shown as VC in FIG. 5 as the charging and discharging of the capacitor 320 take place in turn. With the voltage variation, voltage detecting circuit 225 outputs a series of high voltage signals and low voltage signals, which results in the state clock signal CLKCT. In the present invention, different state resistors along with the state capacitor 320 result in various charging/discharging period, which satisfies the requirement of different state signals. Count of the state clock signal CLKCT from voltage detecting circuit 225 can be obtained by a counter 230 and be forwarded to registers 231, 233, 235, 237. A register then keeps the count and sends a corresponding state signal to the pulse generator 26.

In order to alleviate the noise interference in the circuit, the first threshold can be set to meet the system requirement. Voltage at node C will be regarded as a valid signal only when larger than the first threshold. Also the second threshold ought to be larger than the first threshold for the correction functioning of the circuit.

In order to reduce interference from the Gaussian noise, the present invention further adopts a edge-triggered flip flop and a frequency divider in between the voltage detecting circuit 225 and counter 230 in the state configuring device 22. The frequency divider 227 can perform frequency division of the state clock signal CLKCT by means of a value “ncon”. The value “ncon” is to be set in proportion to the amplitude of the noise. When the noise is stronger, the value “ncon” is set to be a large value, the value “ncon” being smaller when the noise is low.

Signal H/L of FIG. 5 shows the waveform diagram when the frequency divider 227 divides the frequency by the value “ncon”. The edge-triggered flip flop 229 can function as a leading edge-triggered flip flop to output a positive pulse “enstate” to the state machine 221 when experiencing a leading edge 521, 523, or 525. The state machine 221 receives the positive pulse “enstate” and proceeds from its present status (such as overlapped status 541) to another status (such as delayed status 543), which initiates the process of charging/discharging and counting in the next status. Also the edge-triggered flip flop 229 sends another negative pulse CLR at an interval of a period after the positive pulse to reset the counter to zero.

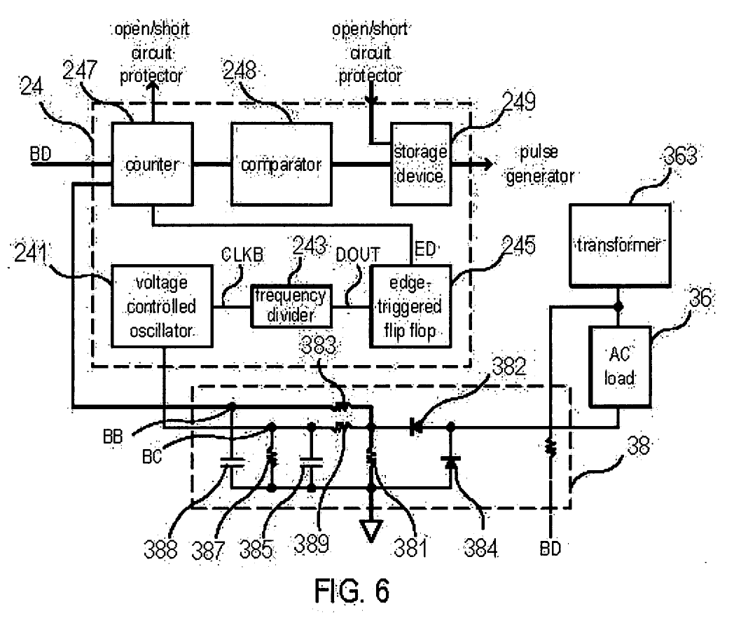

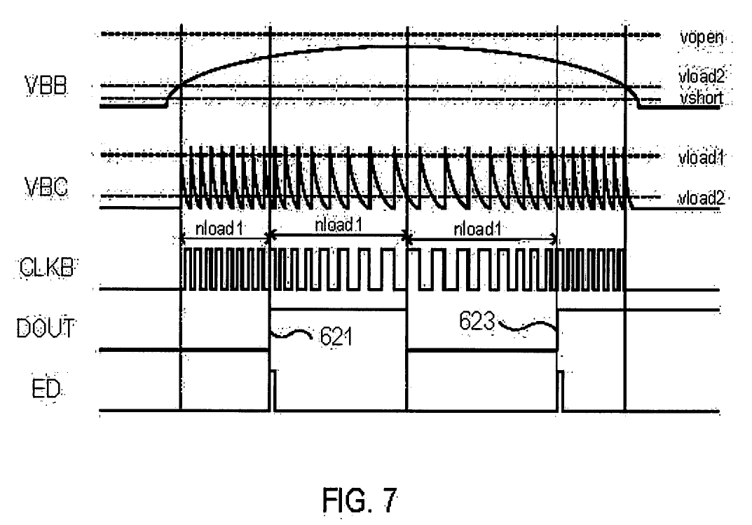

Please refer to FIG. 6 and FIG. 7, which show the block diagram and waveform diagram of the power detector and a part of the block diagram of the feedback circuit. The power detector 24 adopts the following components: a voltage controlled oscillator VCO 241, a frequency divider 243, an edge-triggered flip flop 245, a counter 247, a comparator 248, and a storage device 249. The feedback circuit 38 includes a plurality of diodes, a plurality of resistors, and a plurality of capacitors. At the first diode 382, the p-type end is connected to the output of the AC load 36 while the n-type end is connected to the feedback resistor 389, a first resistor 381 and a second resistor 383. At the second diode 384, the n-type end is connected to the output of AC load 36 and the p-type end of the first diode 382. The p-type end of the second diode 384 is grounded and also connected to the first resistor 381. The first capacitor 385 is connected to a third resistor 387 and the feedback resistor 389 at node BC with the first capacitor 385 and the third resistor 387 grounded at the other end. The second capacitor 388 is connected to the second resistor 383 at node BB.

The voltage controlled oscillator 241 is connected to node BC, which results in a charging/discharging circuit along with the first capacitor 385 and the third resistor 387. The voltage controlled oscillator 241 outputs a low voltage signal when the voltage at BC is higher than a first default power voltage vload1. The voltage controlled oscillator 241 produces a high voltage signal when the voltage of the node BC is lower than a second default power voltage vload2. During the presence of the high voltage signal the voltage controlled oscillator 241 charges the capacitor 385 while the capacitor is discharged through the third resistor 387 at the presence of low voltage signal. The voltage variation of node BC is shown as VBC in FIG. 7. By means of charging and discharging, the voltage controlled oscillator 241 produces a series of high voltage and low voltage signals, which represents a clock signal CLKB for power. A frequency divider achieves frequency division of CLKB by a first power factor nload1. The output of frequency divider 243 is also shown in FIG. 7 as DOUT. When the output of frequency divider 243 is a leading edge such as 621 or 623, the edge triggered flip flop 245 outputs a positive pulse signal, shown as ED in FIG. 7.

To avoid noise and incorrect power detection, the counter 247, in addition to a input connected to the edge triggered flip flop 245 for the count of positive pulse signals, is further equipped with a power detector detecting the voltage at node BB. While the voltage at node BB is lower than a first power voltage vload1, the counter 247 stops counting. The counter 247 counts while the voltage is higher than vload1.

In addition, period of the oscillation circuit resulting from the second capacitor 388 and second resistor 383 varies according to the voltage at the input of the feedback resistor 389. Higher voltage (more current and higher power) results in longer oscillation period while lower voltage (less current and lower power) results in shorter oscillation period. Therefore, the count of the counter 247 becomes larger when the voltage at VBB is larger than the power voltage vload1. Because a large count represents a large power at the load, the present invention is able to rapidly obtain an accurate power at the load. The count is then forwarded to the comparator 248 and compared with a default second power factor. As an outcome of the comparison, a signal for increase is sent when the count is smaller than the second power factor and, likewise, a signal for decrease when count is larger than the second power factor. The result of the comparison will be stored in the storage device 249 which has two counters respectively count the signal for increase and signal for decrease. Responding to the output of the comparator 248, the storage device 249 generates a power adjusting signal to the pulse generator 26. Therefore the waveform signal of pulse generator 26 can be adaptable to achieve constant power output.

In the power detection scheme above, the first power factor nload1 is determined by the period of the power detection. A larger nload1 results in a larger the period of the power detection. The smaller power factor benefits from a fast result of the power detection while decreasing immunity to noise interference. Therefore, the first power factor is to be set according to the practical need of the system.

Furthermore, the second power factor is determined by the load and the feedback resistor 389. Under the same load, the second power factor varies linearly to the feedback resistor 389. Given a system load, it is possible to determine the second power factor and achieve constant power output by matching the system with an appropriate feedback resistor 389.

Also, the feedback circuit 38 further includes a serial of cascaded resistors which connect to the transformer 363 and the AC load 36 at one end and to the counter 247 at the other end. The counter 247 equipped with a voltage detector can detect the open/short circuit status of the AC load 36 when the voltage at node BB is higher than a default open circuit voltage (vopen), or when the voltage is lower than a short circuit voltage (vshort). Likewise the detection of the open/short circuit status of the transformer 363 takes place when the voltage at node BD is larger than the open circuit voltage (vopen), or smaller than the short circuit voltage (vshort). The counter 274 further outputs an open/short circuit signal to the open/short circuit protector 29 to enable the protecting signal “stop” of the open/short circuit protector 29. In the power detector 24, the storage device 249 is connected to the open/short circuit protector 29. When a protecting signal “stop” is received, the count of signal for increase and decrease is disabled. Also disabled is the output of the power adjusting signal to the pulse generator 26.

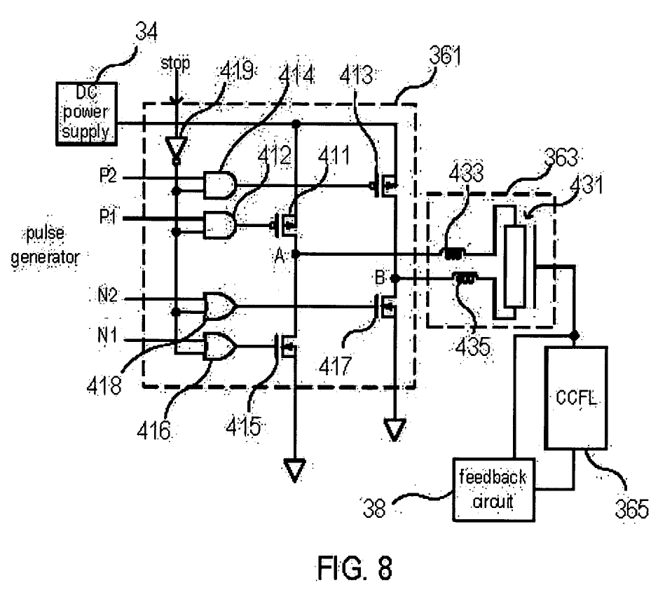

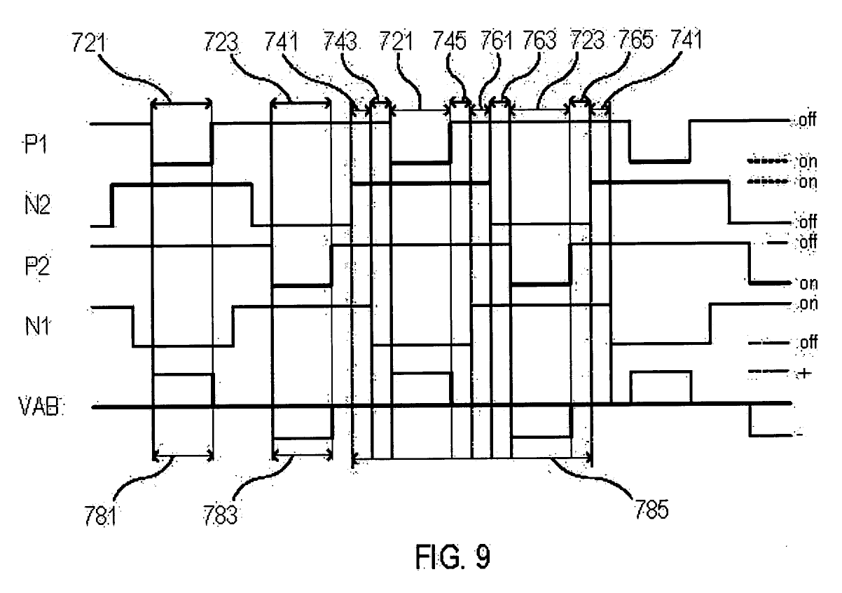

Please refer to FIG. 8 and FIG. 9, which show the diagrams of the driving device and transformer of the present invention. The driving device 361 includes a first P-channel Metal Oxide Semiconductor Field Effect Transistor (PMOS FET) 411, a second PMOS FET 413, a first NMOS FET 415, and a second NMOS FET 417. Sources of the first and second PMOS FET 411, 413 are connected to the DC power supply 34 while the drains are connected respectively to the drains of the first and second NMOS FET 415, 417. Also the drains of the first and second PMOS FET 411, 413 are connected to a piezoelectric ceramic transformer 431 through a first inductor 433 at node A and second inductor 435 at node B.

The pulse generator 26 generates four waveform signals P1, P2, N1, and N2, according to the state signal from state configuring device 22 along with the power adjusting signal, protecting signal, digital dimming signal. The waveform signals P1 and P2 are forwarded respectively to the gates of first PMOS FET 411 and the second PMOS FET 413; the waveform signals N1 and N2 are forwarded respectively to the gates of first NMOS FET 415 and the second NMOS FET 417.

Since the waveform signals perform precise state configuration, two cycles of the status signals (overlap, delay, base light, dim frequency, and echo) are set as a complete driving period 785 to synchronize with the driving device 361. When the state signal is at the first “overlap” status, waveform signals P1, P2, N1, and N2 are set to be at a high voltage. Correspondingly, the first PMOS FET 411 is turned off; the second NMOS FET 417 is turned on; the second PMOS FET 413 is turned off, the first NMOS FET 415 is turned on. And the voltage between node A and node B is zero, shown as the first overlap 741 in FIG. 9. When the state signal is at the first “delay” status, waveform signals P1, N2, P2, and N1 are set, respectively, to be at high voltage, high voltage, high voltage, and low voltage. Correspondingly, the first PMOS FET 411 is turned off; the second NMOS FET 417 is turned on; the second PMOS FET 413 is turned off, the first NMOS FET 415 is turned off. And the voltage between node A and node B is zero, shown as the first delay 743 in FIG. 9. When the state signal is at the first driving status (namely the status of base light and dim frequency), waveform signals P1, N2, P2, and N1 are set, respectively, to be at low voltage, high voltage, high voltage, and low voltage. Correspondingly, the first PMOS FET 411 is turned on; the second NMOS FET 417 is turned on; the second PMOS FET 413 is turned off, the first NMOS FET 415 is turned off. And the voltage between node A and node B is an positive voltage, shown as the first conductive duration 721 with the first driving width 781 in FIG. 9. When the state signal is at the first “echo” status, waveform signals P1, N2, P2, and N1 are set, respectively, to be at high voltage, high voltage, high voltage, and low voltage. Correspondingly, the first PMOS FET 411 is turned off; the second NMOS FET 417 is turned on; the second PMOS FET 413 is turned off, the first NMOS FET 415 is turned off. And the voltage between node A and node B is zero, shown as the first echo 745 in FIG. 9.

When the state signal is at the second “overlap” status, waveform signals P1, N2, P2, and N1 are set, respectively, to be at high voltage, high voltage, high voltage, and high voltage. Correspondingly, the first PMOS FET 411 is turned off; the second NMOS FET 417 is turned on; the second PMOS FET 413 is turned off, the first NMOS FET 415 is turned on. And the voltage between node A and node B is zero, shown as the second overlap 761 in FIG. 9. When the state signal is at the second “delay” status, waveform signals P1, N2, P2, and N1 are set, respectively, to be at high voltage, low voltage, high voltage, and high voltage. Correspondingly, the first PMOS FET 411 is turned off; the second NMOS FET 417 is turned off; the second PMOS FET 413 is turned off, the first NMOS FET 415 is turned on. And the voltage between node A and node B is zero, shown as the second delay 763 in FIG. 9. When the state signal is at the second driving status (namely the status of base light and dim frequency), waveform signals P1, N2, P2, and N1 are respectively set to be at high voltage, low voltage, low voltage, and high voltage. Correspondingly, the first PMOS FET 411 is turned off; the second NMOS FET 417 is turned off; the second PMOS FET 413 is turned on, the first NMOS FET 415 is turned on. And the voltage between node A and node B is an negative voltage, shown as the second conductive duration 723 with the second driving width 783 in FIG. 9. When the state signal is at the second “echo” status, waveform signals P1, N2, P2, and N1 are set, respectively, to be at high voltage, low voltage, high voltage, and high voltage. Correspondingly, the first PMOS FET 411 is turned off; the second NMOS FET 417 is turned off; the second PMOS FET 413 is turned off, the first NMOS FET 415 is turned on. And the voltage between node A and node B is zero, shown as the second echo 765 in FIG. 9.

By calculating the overlap duration of NMOS FET and the delay duration of NMOS FET and PMOS FET, zero voltage switching is implemented. Also because each of the driving duration is followed by the echo of which the duration is precisely calculated, echo energy of the transformer can be better utilized and therefore greater efficiency can be achieved. The same method can be applied to AC load 36 of cold cathode fluorescent lamp 365 as well as the other components driven by the AC power.

At last, driving device 361 in the present invention is able to further includes a Not gate 419, a first AND gate 412, a second AND gate 414, a first OR gate 416, and a second OR gate 418. The Not gate 419 is connected to the open/short circuit protector 29 to receive the protecting signal stop; the Not gate 419 then outputs its inversed signal to inputs of the first AND gate 412, the second AND gate 414, the first OR gate 416, and the second OR gate 418. The other inputs of the first AND gate 412, the second AND gate 414, the first OR gate 416, and the second OR gate 418 are connected, respectively, to the gates of the first PMOS FET 411, the second PMOS FET 413, the first NMOS FET 415, and the second NMOS FET 417. With the connection described above, the open/short circuit protector 29 is able to protect the components of the system from damage by terminating the operation of the PMOS FET and NMOS FET of the driving device 361 with the protecting signal stop at the situation when the system is short/open circuited, when the “turn off” signal is received, or when the light of the system is fully dimmed.

The present invention completely adopts digital circuit components and digital calculation, which overall reduces the power consumption and production cost, and enables fully utilization of the echo energy during transforming.

1. A digital power control system, comprising:
a direct current (DC) power supply for said system;
a state configuring device, generating a plurality of state signals each with a corresponding output, wherein each output can individually output said corresponding state signal by selection;
a pulse generator connected to said state configuring device, receiving and converting said state signals of said state configuring device to a plurality of waveform signals;
a driving device connected to said DC power supply and said configuration device, outputting a driving voltage according to said waveform signal from said pulse generator;
a transformer, connected to said driving device, transforming said driving voltage to an AC operating voltage; and
an alternating current (AC) load, connected to said transformer, operating on said AC operating voltage.

2. The digital power control system of claim 1, wherein a plurality of sate resistors, each corresponding to one state signal and connected to a grounded state capacitor at one end, are further connected to said state configuring device at said other end.

3. The digital power control system of claim 2, wherein said state configuring device further comprises:
a state machine, generating a plurality of status signals and having a plurality of outputs, each corresponding to one status signal, wherein each output can selectively output said corresponding status signal;
a switch connected to said outputs of said state machine, further comprising a plurality of ports each connected to a corresponding state resistor, wherein said state capacitors and said state resistors results in a plurality of charging/discharging circuits;
a voltage detecting circuit with the input connected to said state capacitors and said state resistors to detect voltage of said state capacitors, wherein voltage variation of said configuration capacitors determines an output of a state clock signal;
a counter connected to said voltage detecting circuit, counting said state clock signal and outputting a data signal when count of said state clock signal reaches a state value; and
a plurality of state registers each corresponding to said status signals of said state machine and connected to an output of said counter, wherein said state registers output said corresponding state signal according to said data signal received.

4. The digital power control system of claim 3, in between said voltage detecting circuit and said counter of said state configuring device further comprising:
a frequency divider connected to said voltage detecting circuit, enforcing frequency division of said state clock signal with said state value being denominator; and
an edge triggered flip flop connected to said frequency divider, triggered by a edge of a signal from frequency divider output and outputting a status switching signal to said state machine which enables switch of said state machine to its next output;
wherein said counter, connected to an output of said edge triggered flip flop and counting number of said status switching signals and outputting a data signal to each state register.

5. The digital power control system of claim 4, wherein said edge triggered flip flop is a leading edge triggered flip flop.

6. The digital power control system of claim 3, wherein said status signals comprise an overlap signal, a delay signal, a base light signal, a dim frequency signal, and an echo signal.

7. The digital power control system of claim 3, wherein said switch comprises a plurality of three state switches, each corresponding to one status signals, with controlling ports of said three state switches each connected to one corresponding outputs of said state machine at one end and grounded at said other end so as to result in charging/discharging circuits together with each state resistor and state capacitor.

8. The digital power control system of claim 7, wherein said status signals enable said three way switches so that said three way switches conduct during high voltage and turn off during low voltage.

9. The digital power control system of claim 4, wherein said voltage detecting circuit outputs a high voltage signal when the voltage at the input thereof is lower than a first state voltage and outputs a low voltage signal when the voltage at the input thereof is higher than a second state voltage so that series of said high voltage signals and low voltage signals constitute said state clock signal outputting to said frequency divider.

10. The digital power control system of claim 9, wherein said voltage detecting circuit further comprises a charging output connected to said state capacitor and to each state resistor, said charging output charging said state capacitor when voltage at said input of said voltage detecting circuit is smaller than said first state voltage and stopping charging when voltage at said input of said voltage detecting circuit is higher than said second state voltage.

11. The digital power control system of claim 9, wherein said first state voltage is smaller than said second state voltage.

12. The digital power control system of claim 4, wherein manipulation of said state value determines reduction of interference of Gaussian noise.

13. The digital power control system of claim 2, wherein capacitance of said state capacitor and resistance of said state resistor can be configured to meet the requirement of users.

14. The digital power control system of claim 1, further comprising:
a feedback circuit, connected to said AC load; and
a power detector connected to said feedback circuit and said pulse generator to detect operating power of said AC load and send out a power adjusting signal to said pulse generator so that said waveform signals can be altered to adjust power of said AC load.

15. The digital power control of claim 14, wherein said feedback circuit comprises:
a first capacitor with one end connected to said other end of said feedback resistor and said other end grounded;
a third resistor with parallel connection to said first capacitor, wherein said third resistor along with said first capacitor results in a charging/discharge circuit; and
a second capacitor with one end connected to said second resistor and grounded at said other end;
wherein said first capacitor and said feedback resistor share one connection to said power detector.

16. The digital power control system of claim 15, wherein said power detector comprises:
a voltage controlled oscillator, comprising:
a controlling port connected to said feedback resistor and said first capacitor, charging and discharging said charging/discharging circuit resulting from said first capacitor and said third resistor; and
an output, outputting a low voltage signal when voltage at said controlling port is higher than a first power voltage and a high voltage signal when voltage at said controlling port is lower than a second power voltage so that series of high voltage signals and low voltage signals result in a power clock signal;
a frequency divider connected to the output of said voltage controlled oscillator, making frequency division of said power clock signals with a first power factor as a denominator;
an edge triggered flip flop connected at its input to said frequency divider, triggered by edges of signals from said frequency divider and outputting a triggering signal from output thereof;
a counter with an input connected to said output of said edge triggered flip flop so as to count triggering signals and output the count value;
a comparator connected to said output of said counter for comparing count value from said counter with a second power factor so as to output a minus signal when the count value from said counter is larger than said second power factor and a plus signal when the count value from second said counter is smaller than said second power factor; and
a storage device with an input connected to said output of said comparator, generating said power adjusting signal to said pulse generator based on signals from said comparator so that said pulse generator can output said waveform signal according to said power adjusting signal and said state signals.

17. The digital power control system of claim 16, wherein said counter further comprises a power detector with a controlling port connected between said second resistor and said second capacitor of said feedback circuit so that said counter counts while voltage at said controlling port is higher than said second power voltage, and stops counting while voltage at said controlling port is smaller than said second power voltage.

18. The digital power control system of claim 16, wherein said first power voltage is higher than said second power voltage.

19. The digital power control system of claim 16, wherein said first power factor is dependent on period of power detection.

20. The digital power control system of claim 16, wherein said second power factor is dependent on a default load current and resistance of said feedback resistor.

21. The digital power control system of claim 14, further comprising a signal converter with an input receiving an analog dimming signal and converting said analog dimming signal to an digital dimming signal to output to said pulse generator so that said pulse generator can generate said waveform signal according to said digital dimming signal and said state signal.

22. The digital power control system of claim 21, further comprising an open/short circuit protector with a plurality of inputs connected to said signal converter and said power detector, wherein said open/short circuit protector receives an pulse width modulated signal and a turn-on/off signal, outputting a protecting signal to disable said driving device and to stop said power detector from sending power adjusting signal under one and one of the combination of the following conditions when said analog dimming signal completely dims brightness, when said pulse width modulated signal completely dims brightness, when said turn-on/off signal is off, and when load of said power detector is open or short circuited.

23. The digital power control system of claim 14, wherein said state configuring device, said pulse generator, and said power detector can be integrated into a driving microcontroller chip.

24. The digital power control system of claim 6, wherein said driving device comprises:
a first PMOS FET with the source connected to said DC power and the drain to a first node;
a second PMOS FET with the source connected to DC power and the drain to a second node;
a first NMOS FET with the drain connected to said second node and the source grounded; and
a second NMOS FET with the drain connected to said second node and the source grounded;
wherein said first node and said second node are respectively connected to different ends of said transformer and each gates of MOS FETs are individually connected to said outputs of said pulse generator with each waveform signal dominating conduction of each MOS FETs so as to output said driving output to said transformer.

25. The digital power control system of claim 24, wherein said waveform signals further comprises a first waveform signal, a second waveform signal, a third waveform signal, and a fourth waveform signal respectively connected to said first PMOS FET, said second PMOS FET, said first NMOS FET, and said second NMOS FET in order to control the conduction of MOS FETs.

26. The digital power control system of claim 25, wherein period of said driving device is twice of that of said status signals.

27. The digital power control system of claim 26, wherein said first, second, third, and fourth waveform signals are at high voltage when said status signal is at a first overlap status.

28. The digital power control system of claim 26, wherein said first waveform signal is at high voltage; said second waveform signal is at high voltage; said third waveform signal is at high voltage, and said fourth waveform signal is at low voltage when said status signal is at a first delay status.

29. The digital power control system of claim 26, wherein said first waveform signal is at low voltage; said second waveform signal is at high voltage; said third waveform signal is at high voltage, and said fourth waveform signal is at low voltage when said status signal is at a first base light and a first dim frequency status.

30. The digital power control system of claim 26, wherein said first waveform signal is at high voltage; said second waveform signal is at high voltage; said third waveform signal is at high voltage, and said fourth waveform signal is at low voltage when said status signal is at a first echo status.

31. The digital power control system of claim 26, wherein said first waveform signal is at high voltage; said second waveform signal is at high voltage; said third waveform signal is at high voltage, and said fourth waveform signal is at high voltage when said status signal is at a second overlap status.

32. The digital power control system of claim 26, wherein said first waveform signal is at high voltage; said second waveform signal is at low voltage; said third waveform signal is at high voltage, and said fourth waveform signal is at low voltage when said status signal is at a second delay status.

33. The digital power control system of claim 26, wherein said first waveform signal is at high voltage; said second waveform signal is at low voltage; said third waveform signal is at low voltage, and said fourth waveform signal is at high voltage when said status signal is at a second base light and a second dim frequency status.

34. The digital power control system of claim 26, wherein said first waveform signal is at high voltage; said second waveform signal is at low voltage; said third waveform signal is at low voltage, and said fourth waveform signal is at high voltage when said status signal is at a second echo status.

35. The digital power control system of claim 24, wherein said driving device further comprises:
a Not gate, receiving a protecting signal at the input thereof and outputting a inversed signal at the output thereof;
a first AND gate with the input thereof connected to an output of said first waveform signal of said pulse generator and said output of said Not gate respectively, and the output thereof connected to said gate of said first PMOS FET;
a second AND gate with the input thereof connected to an output of said second waveform signal of said pulse generator and said output of said Not gate respectively, and the output thereof connected to said gate of said second PMOS FET;
a first OR gate with the input thereof connected to an output of said third waveform signal of said pulse generator and said output of said Not gate respectively, and the output thereof connected to said gate of said first NMOS FET; and
a second OR gate with the input thereof connected to an output of said fourth waveform signal of said pulse generator and said output of said Not gate respectively, and the output thereof connected to said gate of said first NMOS FET;
wherein each logic gate disables said MOS FETs of said driving device according to said protecting signals.
